(19) United States
(12) Patent Application Publication
(10) Pub. No.: US 2014/0375513 A1
(43) Pub. Date: Dec. 25, 2014

(54) ANTENNA DEVICE AND DISPLAY APPARATUS HAVING THE SAME

(71) Applicant: SAMSUNG ELECTRONICS CO., LTD., Suwon-si (KR)

(72) Inventors: Hyun-koo KANG, Yongin-si (KR); Jun-Seok KANG, Bucheon-si (KR); Ji-eun SHIN, Suwon-si (KR); Scott Seongwook LEE, Suwon-si (KR)

(73) Assignee: SAMSUNG ELECTRONICS CO., LTD., Suwon-si (KR)

(21) Appl. No.: 14/310,800

(22) Filed: Jun. 20, 2014

(30) Foreign Application Priority Data
Jun. 21, 2013 (KR) 10-2013-0071690

(51) Int. Cl. H01Q 1/22; H01Q 1/52; H01Q 13/10

(52) U.S. Cl. CPC H01Q 1/22; H01Q 13/10; H01Q 1/526
USPC 343/720

(57) ABSTRACT

An antenna device includes: a slot antenna unit configured to be positioned on a shield plate disposed in a rear side of a display; and a communication module configured to be connected to the slot antenna unit, to transmit and receive a signal to and from an external wireless device via the slot antenna unit. The slot antenna unit is exposed toward the display to radiate an antenna signal to the display.

### CROSS-REFERENCE TO RELATED APPLICATION

This application claims priority from Korean Patent Application No. 10-2013-0071690, filed on Jun. 21, 2013 in the Korean Intellectual Property Office, the disclosure of which is incorporated herein by reference in its entirety.

### BACKGROUND

1. Field

Apparatuses and methods consistent with exemplary embodiments relate to providing an antenna device and a display apparatus having the same, and more particularly, to providing an antenna device that maintains a signal radiation pattern of an antenna in order to improve a signal reception performance, and the display apparatus having the same.

2. Description of the Related Art

In general, a display apparatus, as for example, an Internet protocol television (IPTV), a smart TV, or the like, which transmits and receives a signal to and from an external wireless device, includes an antenna. An antenna pattern is directly formed on a printed circuit board (PCB), which is fixedly installed at a back chassis of the display apparatus, to be used as the antenna.

However, if the display apparatus is a high-end TV, for example, a light-emitting diode (LED) TV or a large format display (LFD) installed outside, for example, for corporate advertisement or public relation, a material of a rear case is changed from a plastic material to a metal material.

In this case, an existing antenna device is disposed between a back chassis formed of a metal material and the rear case formed of the metal material and thus is placed in a shielded environment. Therefore, a radiation pattern is deteriorated, and a characteristic of the antenna is noticeably deteriorated more than that of a general antenna.

### SUMMARY

Exemplary embodiments may address at least the above problems and/or disadvantages and other disadvantages not described above. Also, the exemplary embodiments are not required to overcome the disadvantages described above, and an exemplary embodiment may not overcome any of the problems described above.

One or more exemplary embodiments provide an antenna device that, if a rear case of a display apparatus is formed of a metal material, is exposed toward a display to maintain a signal radiation pattern of an antenna in front of the display in order to improve a signal reception performance, and the display apparatus having the same.

According to an aspect of an exemplary embodiment, there is provided an antenna device including: a slot antenna unit configured to be positioned on a shield plate disposed in rear of a display in order to shield an electromagnetic wave generated from the display; and a communication module configured to be connected to the slot antenna unit in order to transmit and receive a signal to and from an external wireless device through the slot antenna unit. The slot antenna unit may be exposed toward the display to radiate an antenna signal in front of the display.

The shield plate may include an antenna signal radiation opening through which the antenna signal of the slot antenna unit passes, and the slot antenna unit is set in a position corresponding to the antenna signal radiation opening.

The slot antenna unit may include: a conductive member configured to be detachably installed on the shield plate; and at least one radiation pattern configured to be perforated in the conductive member. The at least one radiation pattern may be disposed inside the antenna signal radiation opening.

The shield plate may include combination means with which the slot antenna unit is detachably combined.

The combination means may be formed as a pair of slots that are disposed in parallel along sides of the antenna signal radiation opening facing each other. The combination means may be a conductive tape that simultaneously tapes the slot antenna unit and the shield plate. The combination means may be a plurality of combination members. The combination means may be a plurality of fixing protrusions that are formed into a single body along with the shield plate and is formed along a part around the antenna signal radiation opening.

A connection terminal of the communication module may be directly soldered to a connection terminal of the slot antenna unit.

A connection terminal of the communication module may be connected to a connection terminal of the slot antenna unit through an electric cable.

The communication module may include first and second communication circuit units that transmit and receive at least two or more different signals. The slot antenna unit may include at least one first radiation pattern connected to the first communication circuit unit and at least one second radiation pattern connected to the second communication circuit unit.

Foreign material intercepting members may be attached on the slot antenna unit to prevent foreign materials from flowing into the first and second radiation patterns. The foreign material intercepting members may be an insulating tape or an insulating film.

The shield plate may be formed of an electric conductor, and the slot antenna unit may form a part of the shield plate. The slot antenna unit may include at least one radiation pattern that is perforated in a part of the shield plate.

According to an aspect of an exemplary embodiment, there is provided a display apparatus including: a display; a shield plate configured to be formed of a metal material and to be disposed in rear of the display in order to shield an electromagnetic wave generated from the display; a rear case configured to be formed of a metal material and enclose a back of the shield plate; and an antenna device configured to include a slot antenna unit which is disposed on the shield plate and in which at least one radiation pattern is perforated and a communication module which is electrically connected to the slot antenna unit to transmit and receive a signal to and from an external wireless device through the slot antenna unit. The slot antenna unit may be exposed toward the display to radiate an antenna signal in front of the display.

### BRIEF DESCRIPTION OF THE DRAWINGS

The above and/or other aspects will become more apparent by describing certain exemplary embodiments with reference to the accompanying drawings, in which:

FIG. 1 is a side view illustrating a display apparatus according to an exemplary embodiment;

FIG. 2 is a view illustrating the display apparatus that is seen from direction II of FIG. 1;

FIG. 3 is a view illustrating a shield plate that is disposed inside a display apparatus and an antenna device that is installed on the shield plate, according to an exemplary embodiment;

FIG. 4 is an enlarged view of part IV of FIG. 3;

FIG. 5 is a schematic view illustrating a slot antenna unit, according to an exemplary embodiment;

FIG. 6 is an exploded perspective view illustrating the slot antenna unit and the shield plate, according to an exemplary embodiment;

FIG. 7 is a view illustrating the slot antenna unit fixed on the shield plate, according to an exemplary embodiment;

FIG. 8 is a view illustrating the slot antenna unit fixed on the shield plate, according to an exemplary embodiment;

FIG. 9 is a view illustrating the slot antenna unit fixed on the shield plate, according to an exemplary embodiment;

FIG. 10 is a schematic perspective view illustrating foreign material intercepting members attached to a slot antenna unit, according to an exemplary embodiment;

FIG. 11 is a perspective view illustrating a communication module soldered to a conductive member of a slot antenna unit, according to an exemplary embodiment;

FIG. 12 is a perspective view illustrating another connection structure between the slot antenna unit and the communication module of FIG. 11;

FIG. 13 is a view illustrating a slot antenna unit that forms a part of a shield plate and is connected to a communication module through an electric cable, according to an exemplary embodiment; and

FIG. 14 is a view illustrating a slot antenna unit that forms a part of a shield plate and is directly connected to a communication module, according to an exemplary embodiment.

### DETAILED DESCRIPTION OF EXEMPLARY EMBODIMENTS

Certain exemplary embodiments are described in greater detail below with reference to the accompanying drawings.

In the following description, the same drawing reference numerals are used for the same elements even in different drawings. The matters defined in the description, such as detailed construction and elements, are provided to assist in a comprehensive understanding of the exemplary embodiments. Thus, it is apparent that the exemplary embodiments can be carried out without those specifically defined matters. Also, well-known functions or constructions are not described in detail since they would obscure the exemplary embodiments with unnecessary detail.

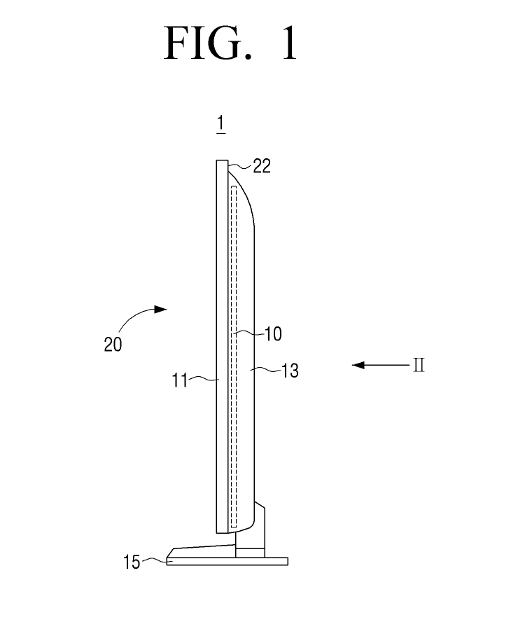

Referring to FIGS. 1 through 3, a display apparatus 1 according to an exemplary embodiment includes a display 11, which is disposed at a front side 20 of the display apparatus 1, and a shield plate 10 that is disposed in a rear side 22 of the display 11, a rear case 13 that is formed of a metal material and is disposed in the rear of the shield plate 10 to protect a back of the display apparatus 1, and an antenna device 100. The display 11 and the rear case 13 are supported by a pedestal 15 that is disposed at a lower part of the display apparatus 1, to maintain an approximately vertical position.

The display 11 may include one of an LED panel, an organic light-emitting diode (OLED) panel, an edge type or direct type liquid crystal display (LCD) panel, and a plasma display panel (PDP).

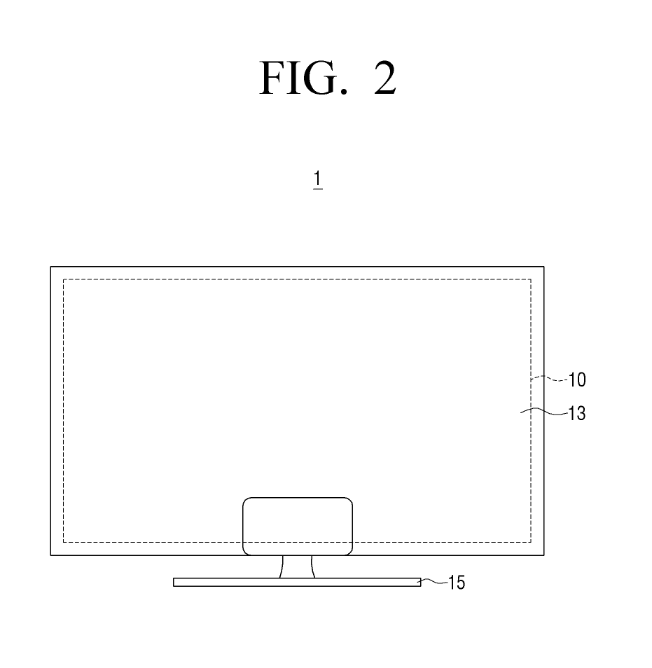

The shield plate 10 that is used as a back chassis is disposed in the rear of the display 11 as shown in FIG. 1 and is formed to have an area approximately corresponding to an area of the display 11 as shown in FIG. 2. The shield plate 10 may intercept electro-magnetic interference (EMI) emitted from the display 11 and may be formed of a metal material in consideration of electro-magnetic compatibility (EMC).

The shield plate 10 may also be formed of a metal material that is an electric conductor so that the antenna device 100 is grounded.

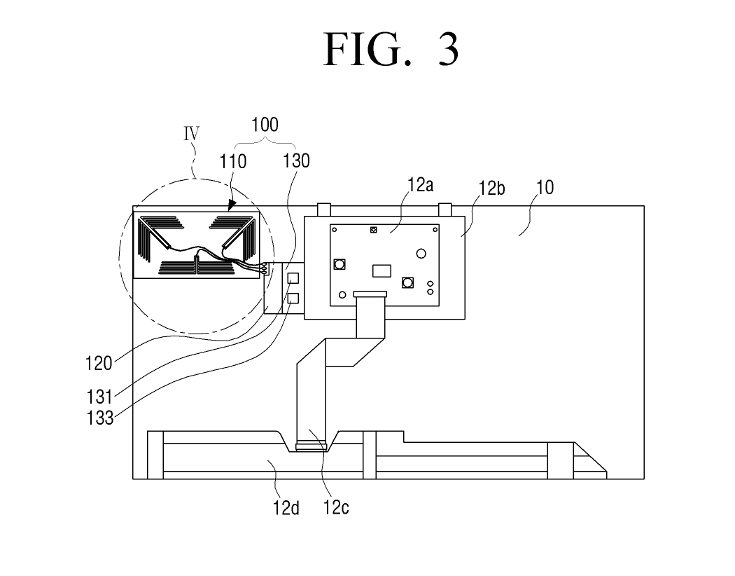

As shown in FIG. 3, the shield plate 10 may have rigidity to fixedly install or support various types of electronic units. For example, a bracket 12b that supports a main PCB 12a, an auxiliary PCB 12d, a data cable 12c that electrically connects the main PCB 12a and the auxiliary PCB 12d to each other, the antenna device 100, etc., may be supported by the shield plate 10.

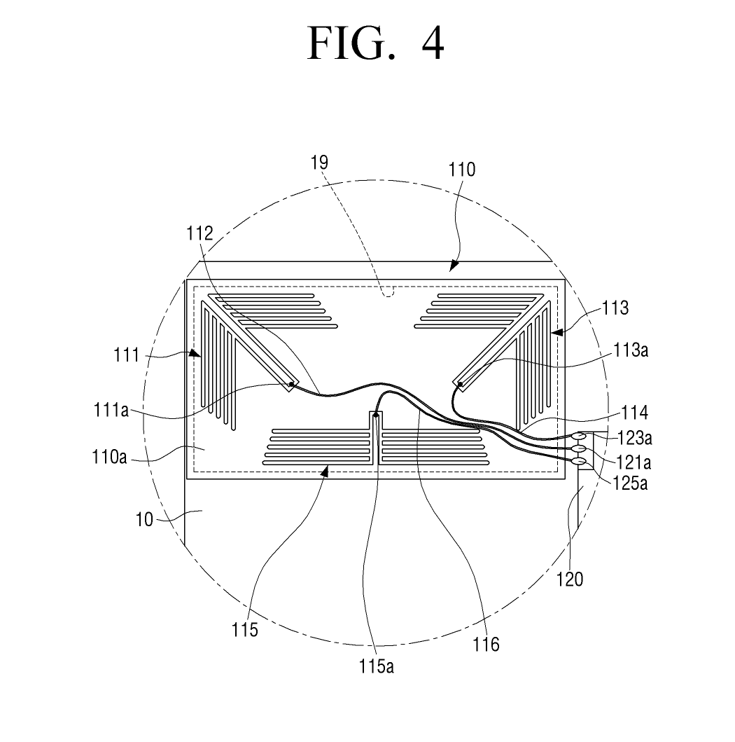

As shown in FIG. 4, an antenna signal radiation opening 19 is formed in the shield plate 10 to radiate an antenna signal from a slot antenna unit 110 of the antenna device 100 toward the front side 20, i.e., the display 11. I.e., the antenna signal radiation opening 19 exposes the slot antenna unit 110 of the antenna device 100 toward the display 11, from the shield plate 10, so that the antenna signal radiated from the antenna unit 110 does not interfere with the shield plate 10.

The slot antenna unit 110 may be positioned in a place distant from the main PCB 12a and the auxiliary PCB 12d, for example, at an upper corner of a side of the shield plate 10, to minimize signal interference from electromagnetic waves generated from the main PCB 12a and the auxiliary PCB 12d. The antenna signal radiation opening 19 may be formed in consideration of a position of the slot antenna unit 110.

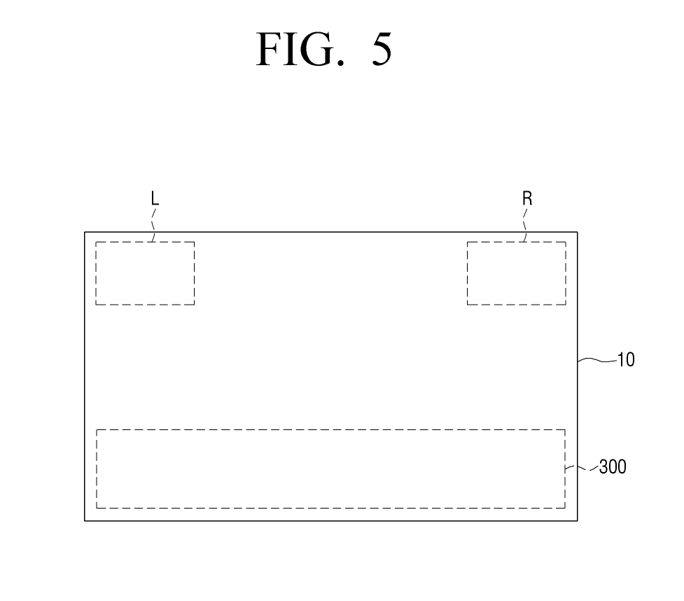

The position of the antenna signal radiation opening 19 may also be relatively changed according to a position of a PCB. For example, as shown in FIG. 5, if electronic units 300 such as PCBs are disposed at a lower part 300 of the shield plate 10, the antenna signal radiation opening 19 may be positioned at an upper part of the shield plate 10, i.e., may be appropriately disposed at an upper left corner L or an upper right corner R of the shield plate 10.

A structure of the antenna device 100 will now be described in detail with reference to FIGS. 3 and 4. The antenna device 100 according to the present exemplary embodiment is a slot antenna device that uses a principle of piercing an opening in a metal plate and exciting the metal plate to generate an electromagnetic wave.

The antenna device 100 includes the slot antenna unit 110 that has a plate shape and a communication module 130 that is connected to the slot antenna unit 110.

The slot antenna unit 110 includes a conductive member 110a that is formed of a metal material in a plate shape, and first radiation patterns 111 and 113 and a second radiation pattern 115 that are perforated in the conductive member 110a.

The conductive member 110a is formed in an approximately rectangular shape so as to correspond to the antenna signal radiation opening 19 of the shield plate 10 but is not limited thereto. Therefore, the conductive member 110a may be formed in various shapes such as a circular shape, an elliptical shape, a polygonal shape, etc. If the conductive member 110a is formed in various shapes as described above, the first radiation patterns 111 and 113 and the second radiation pattern 115 that are perforated in the conductive member 110a may be positioned within an area corresponding to the antenna signal radiation opening 19. This positioning of the first radiation patterns 111 and 113 and the second radiation pattern 115 is to minimize interference of an antenna signal with the shield plate 10, when the antenna signal is radiated from the first radiation patterns 111 and 113 and the second radiation pattern 115.

As seen in FIG. 4, the first radiation patterns 111 and 113 are formed to be approximately symmetric based on a center of the conductive member 110a and radiate a first antenna signal (for example, a Wi-Fi signal). The second radiation pattern 115 is disposed below the first radiation patterns 111 and 113 and radiates a second antenna signal (for example, a Bluetooth signal) that is different from the first antenna signal.

The first radiation patterns 111 and 113 and the second radiation pattern 115 are not limited to patterns illustrated in FIG. 4 and may be formed in various shapes according to the number of different types of signals that are realized by the antenna device 100.

The first radiation patterns 111 and 113 and the second radiation pattern 115 are connected to the communication module 130 through first, second, and third electric cables 112, 114, and 116 (for example, radio frequency (RF) cables). In this case, ends of the first and second electric cables 112 and 114 are respectively connected to first and second connection terminals 111a and 113a of the first radiation patterns 111 and 113, and other ends of the first and second electric cables 112 and 114 are respectively connected to first and second connection terminals 121a and 123a of a connector 120. Also, an end of the third electric cable 116 is connected to a connection terminal 115a of the second radiation pattern 115, and an other end of the third electric cable 116 is connected to a third connection terminal 125a.

The connector 120 is electrically connected to a side of the communication module 130 that is connected to the main PCB 12a.

The communication module 130 may include a first communication circuit unit 131 that transmits and receives a signal to and from an external wireless device through the first radiation patterns 111 and 113 and a second communication circuit unit 133 that transmits and receives a signal to and from the external wireless device through the second radiation pattern 115. The external wireless device that transmits and receives the signals to and from the first and second communication circuit units 131 and 133 may be a remote controller, a smartphone, a tablet personal computer (PC), or the like.

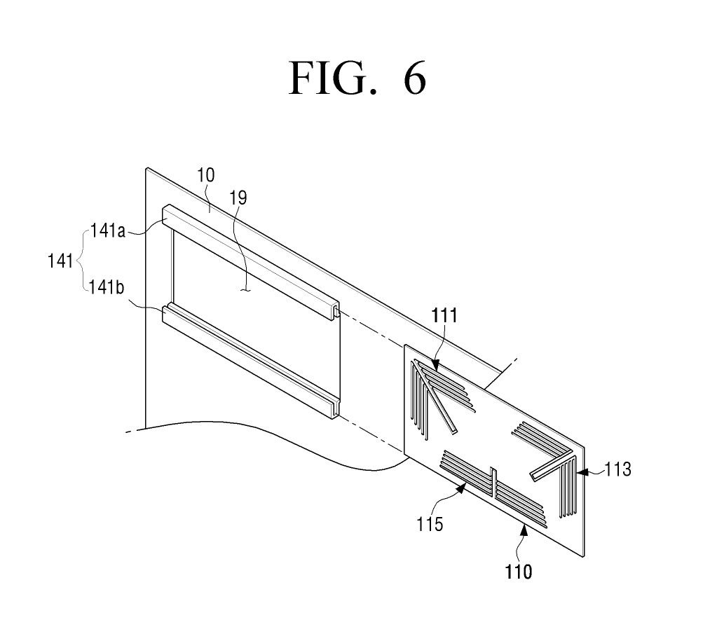

As shown in FIGS. 6 through 9, the slot antenna unit 110 may be detachably joined with the shield plate 10 with at least one of a first member 141, a second member 143, a third member 145, and a fourth member 147. The slot antenna unit 110 may be disposed on the shield plate 10 to dispose the first radiation patterns 111 and 113 and the second radiation pattern 115 inside the antenna signal radiation opening 19, so that the antenna signal does not interfere with the shield plate 10. In other words, the first radiation patterns 111 and 113 and the second radiation pattern 115 may be fully exposed toward the display 11 through the antenna signal radiation opening 19.

Referring to FIG. 6, the first member 141 may include a pair of slots 141a and 141b that are disposed along sides of the antenna signal radiation opening 19 facing each other. Parts of the shield plate 10 may be bent in multi stages to form the slots 141a and 141b. When the slot antenna unit 110 slides into the first member 141 to be joined with the first member 141, upper and lower ends of the slot antenna unit 110 may be respectively stably inserted into the slots 141a and 141b. The slots 141a and 141b may be formed to have widths equal to or thinner than a thickness of the slot antenna unit 110 in order to strongly fix the slot antenna unit 110.

The first member 141 is formed by using the parts of the shield plate 10 in FIG. 6, but this is not limiting. Therefore, a member that is separate from the shield plate 10 may be formed in a slot shape to be welded along the sides of the antenna signal radiation opening 19 facing each other in order to form the first member 141.

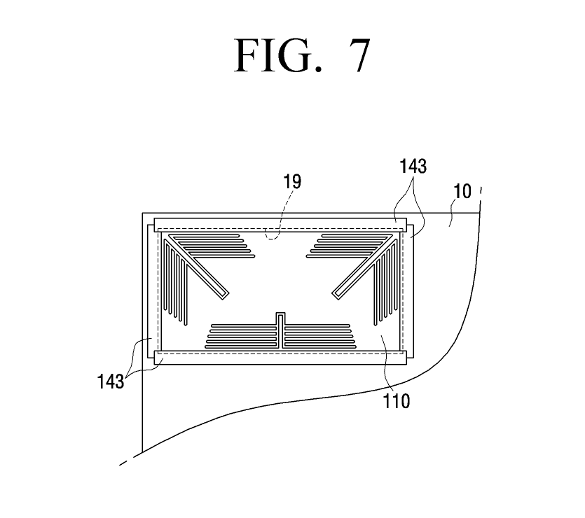

Referring to FIG. 7, the second member 143 may include a conductive tape. In order to fix the slot antenna unit 110 by using the conductive tape 143, the slot antenna unit 110 is placed in a position corresponding to the antenna signal radiation opening 19, and then the conductive tape 143 is simultaneously taped on the slot antenna unit 110 and the shield plate 10 along four sides of the slot antenna unit 110.

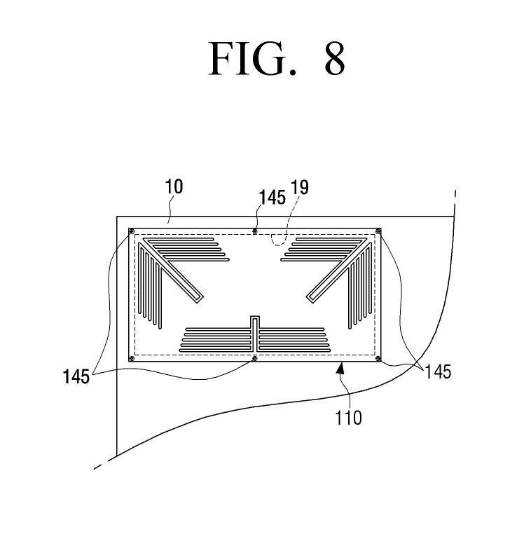

Referring to FIG. 8, the third member 145 may include a plurality of screws. The plurality of screws 145 penetrate through all or some of the four sides of the slot antenna unit 110 and edges of the shield plate 10 surrounding the antenna signal radiation opening 19, to fix the slot antenna unit 110 on the shield plate 10. If the plurality of screws 145 are used as described above, the screws 145 may be separated from the slot antenna unit 110 to easily separate the slot antenna unit 110 from the shield plate 10.

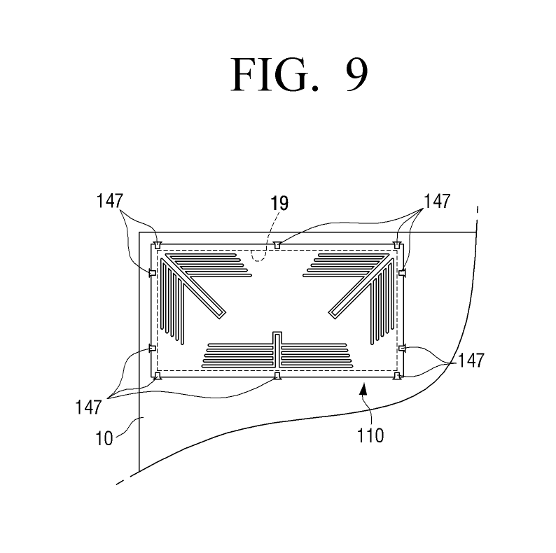

Referring to FIG. 9, the fourth member 147 may include a plurality of fixing protrusions that are formed along edges of the shield plate 10 disposed around the antenna signal radiation opening 19. In this case, the plurality of fixing protrusions 147 form parts of the shield plate 10, and arrangement positions of the plurality of fixing protrusions 147 may be respectively set in positions corresponding to an edge of the slot antenna unit 110 in order to fix the edge of the slot antenna unit 110.

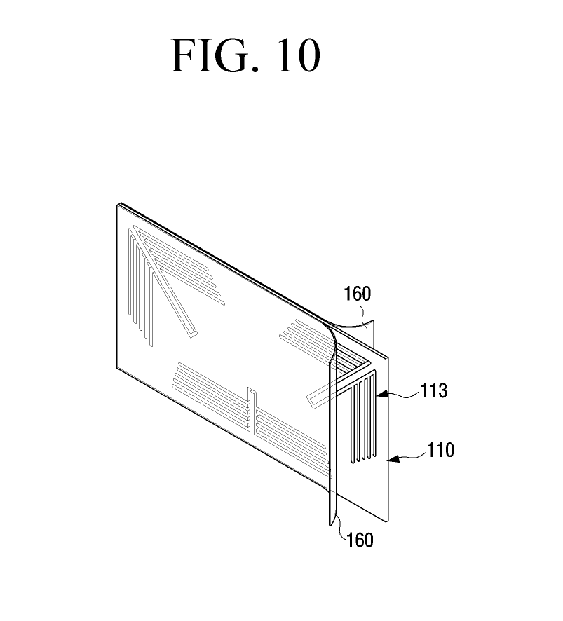

If foreign materials flow into the first radiation patterns 111 and 113 and the second radiation pattern 115, an antenna performance of the slot antenna unit 110 may be deteriorated. Foreign material intercepting members 160 may be attached on both sides of the slot antenna unit 110 as shown in FIG. 10 to prevent the antenna performance from being deteriorated.

The foreign material intercepting members 160 may be formed of an insulating tape or an insulating film (for example, a thin polypropylene-based plastic film).

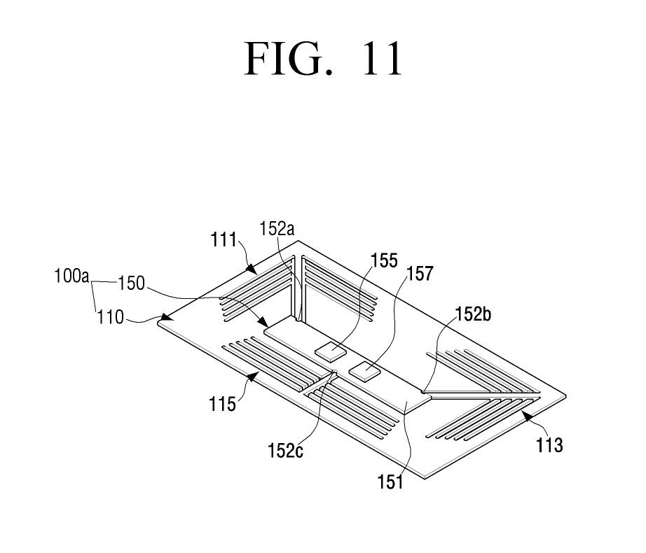

The antenna device 100 according to an exemplary embodiment has a structure in which the slot antenna unit 110 is separated from the communication module 130 but is connected to the communication module 130 through a plurality of electric cables 112, 114, and 116. However, the antenna device 100 is not limited to the above-described structure and may have a structure in which the slot antenna unit 110 and a communication module 150 form a single body as shown in FIG. 11.

Referring to FIG. 11, an all-in-one antenna device 100a may omit the plurality of electric cables 112, 114, and 116, and thus manufacturing cost of a product may be reduced. In the all-in-one antenna device 100a, a plurality of connection terminals 152a, 152b, and 152c of the communication module 150 formed on a PCB 151 are directly soldered to the connection terminals 111a, 113a, and 115a of the first radiation patterns 111 and 113 and the second radiation pattern 115 (refer to FIG. 4).

The plurality of connection terminals 152a, 152b, and 152c are formed in approximately semicircular shapes at end parts of the PCB 151 adjacent to the connection terminals 111a, 113a, and 115a of the first radiation patterns 111 and 113 and the second radiation pattern 115, and a conductive material is coated inside the plurality of connection terminals 152a, 152b, and 152c. The plurality of connection terminals 152a, 152b, and 152c are electrically connected to a first communication circuit unit 155 and a second communication circuit unit 157 through wires.

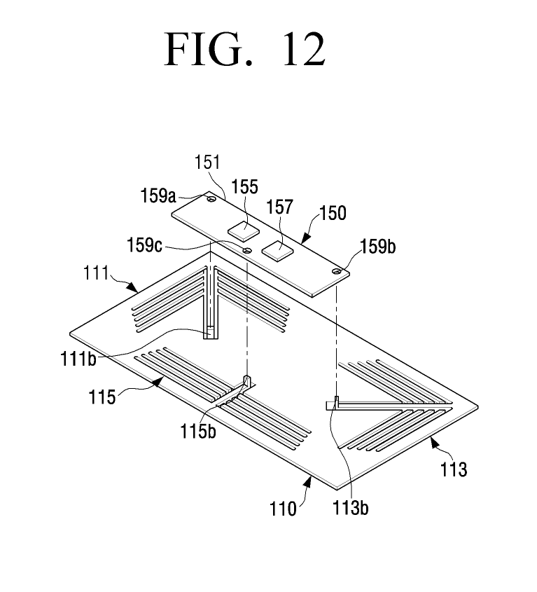

Referring to FIG. 12, in the antenna device 100a, a plurality of connection terminals 159a, 159b, and 159c of the communication module 150 may be formed as through-holes. In this case, ends of the connection terminals 111b, 113b, and 115b of the first radiation patterns 111 and 113 and the second radiation pattern 115 may be bent in the same direction to be inserted into the plurality of connection terminals 159a, 159b, and 159c of the communication module 150. In this structure, the connection terminals 111b and 113b of the first radiation patterns 111 and 113, the connection terminal 115b of the second radiation pattern 115, and the plurality of connection terminals 159a, 159b, and 159c of the communication module 150 are directly soldered.

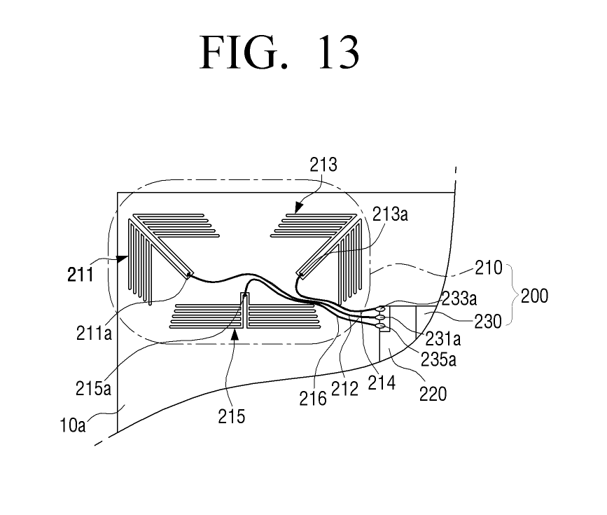

The antenna devices 100 and 100a described above have the structures in which the slot antenna unit 110 is detachably assembled with the shield plate 10 but are not limited to the these structures. As shown in FIG. 13, a slot antenna unit 210 may be formed to be a part of a shield plate 10a.

Referring to FIG. 13, the slot antenna unit 210 may be positioned at an upper corner of the shield plate 10a formed of a metal material. In this case, first radiation patterns 211 and 213 and a second radiation pattern 215 of the slot antenna unit 210 are directly perforated in the shield plate 10a.

The antenna device 200 of FIG. 13 is formed as a separable type in which the slot antenna unit 210 is connected to a communication module 230 through first, second, and third electric cables 212, 214, and 216 but is not limited thereto.

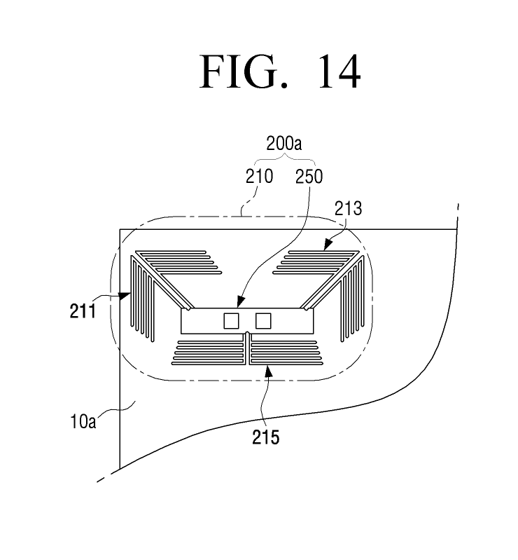

Referring to FIG. 14, the antenna device 200a may be formed as an all-in-one type in which the slot antenna unit 210 is directly soldered to the communication module 250.

In FIGS. 13 and 14, reference numerals 211a and 213a denote connection terminals of the first radiation patterns 211 and 213, reference numeral 215a denotes a connection terminal of the second radiation pattern 215, reference numeral 220 denotes a connector, and reference numerals 231a, 231b, and 231c denote connection terminals of the connector 220.

The foregoing exemplary embodiments and advantages are merely exemplary and are not to be construed as limiting. The present teaching can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. An antenna device comprising:
a slot antenna unit configured to be positioned on a shield plate disposed in a rear side of a display to shield an electromagnetic wave generated by the display; and
a communication module configured to be connected to the slot antenna unit to transmit and receive a signal to and from an external wireless device via the slot antenna unit,
wherein the slot antenna unit is exposed from the shield plate toward the display to radiate an antenna signal in a direction of a front side of the display.

2. The antenna device of claim 1, wherein the shield plate comprises:
an antenna signal radiation opening through which the antenna signal of the slot antenna unit passes,
wherein the slot antenna unit is set in a position corresponding to the antenna signal radiation opening.

3. The antenna device of claim 2, wherein the slot antenna unit comprises:
a conductive member configured to be detachably installed on the shield plate; and
at least one radiation pattern perforated in the conductive member,
wherein the at least one radiation pattern is disposed within an area corresponding to the antenna signal radiation opening.

4. The antenna device of claim 3, wherein the shield plate and the slot antenna unit are configured to be detachably joined with a member.

5. The antenna device of claim 4, wherein the member comprises a pair of slots that are disposed in parallel along side edges of the antenna signal radiation opening facing each other.

6. The antenna device of claim 4, wherein the member comprises a conductive tape that tapes the slot antenna unit and the shield plate to one another.

7. The antenna device of claim 4, wherein the member comprises a plurality of screws.

8. The antenna device of claim 4, wherein the member comprises a plurality of fixing protrusions that are formed integrally with the shield plate along edges of the shield plate disposed around the antenna signal radiation opening.

9. The antenna device of claim 1, wherein a connection terminal of the communication module is directly soldered to a connection terminal of the slot antenna unit.

10. The antenna device of claim 1, wherein a connection terminal of the communication module is connected to a connection terminal of the slot antenna unit with an electric cable.

11. The antenna device of claim 1, wherein the communication module comprises first and second communication circuit units that transmit and receive at least two or more different signals, and
the slot antenna unit comprises at least one first radiation pattern connected to the first communication circuit unit and at least one second radiation pattern connected to the second communication circuit unit.

12. The antenna device of claim 3, wherein foreign material intercepting members are attached to the slot antenna unit to prevent foreign materials from flowing into the at least one radiation pattern.

13. The antenna device of claim 12, wherein the foreign material intercepting members comprise an insulating tape or an insulating film.

14. The antenna device of claim 1, wherein the shield plate is formed of an electric conductor, and the slot antenna unit forms a part of the shield plate.

15. The antenna device of claim 14, wherein the slot antenna unit comprises at least one radiation pattern that is perforated in a part of the shield plate.

16. The antenna device of claim 14, wherein a connection terminal of the communication module is directly soldered to a connection terminal of the slot antenna unit.

17. The antenna device of claim 14, wherein a connection terminal of the communication module is connected to a connection terminal of the slot antenna unit with an electric cable.

18. The antenna device of claim 14, wherein foreign material intercepting members are attached to the slot antenna unit to prevent foreign materials from flowing into the at least one radiation pattern.

19. The antenna device of claim 18, wherein the foreign material intercepting members comprise an insulating tape or an insulating film.

20. A display apparatus comprising:
a display;
a shield plate formed of metal and disposed in a rear side of the display, to shield an electromagnetic wave generated by the display;
a rear case which is formed of metal and encloses a back surface of the shield plate; and
an antenna device comprising:
a slot antenna unit which is disposed on the shield plate and in which at least one radiation pattern is perforated, the slot antenna unit being exposed from the shield plate toward the display to radiate an antenna signal in a direction of a front side of the display, and
a communication module which is electrically connected to the slot antenna unit to transmit and receive a signal to and from an external wireless device through the slot antenna unit.
